(19) United States
(12) Patent Application Publication
(10) Pub. No.: US 2026/0359721 A1
(43) Pub. Date: Nov. 12, 2026

(54) SYSTEM AND METHOD FOR BUILDING LEARNING MODEL

(71) Applicant: SEOUL NATIONAL UNIVERSITY R&DB FOUNDATION, Seoul (KR)

(72) Inventors: Bohyung HAN, Seoul (KR); Geeho KIM, Seoul (KR); Jinkyu KIM, Anyang-si (KR)

(21) Appl. No.: 19/447,390

(22) Filed: Jan. 13, 2026

Related U.S. Application Data
(63) Continuation of application No. PCT/KR2023/021196, filed on Dec. 21, 2023.

(30) Foreign Application Priority Data
Jul. 14, 2023 (KR) 10-2023-0091679
Nov. 24, 2023 (KR) 10-2023-0165478

(51) Int. Cl. G06N 20/00

(52) U.S. Cl. CPC G06N 20/00

(57) ABSTRACT

A learning model building system according to one embodiment includes: a server configured to store and update a global model; and a plurality of agent devices configured to receive the global model from the server, connect the global model between layers of a local model, input a plurality of training data into the local model, and train the local model by calculating a loss between a label value of the training data and an output of the local and global models and updating the local model, and the server receives the trained local model from the plurality of agent devices, and updates the global model using the trained local model.

### CROSS-REFERENCE TO RELATED APPLICATION

This application is a continuation of International Application No. PCT/KR2023/021196 filed on Dec. 21, 2023, which claims the benefit under 35 USC 119(a) of Korean Patent Application No. 10-2023-0165478 filed on Nov. 24, 2023, and Korean Patent Application No. 10-2023-0091679 filed on Jul. 14, 2023, in the Korean Intellectual Property Office, the entire disclosures of which are incorporated herein by reference for all purposes.

### TECHNICAL FIELD

The present disclosure relates to a learning model building system and method for building a learning model using machine learning.

### BACKGROUND

Federated learning refers to a deep learning model training method that protects data privacy. In a federated learning system, training is conducted using a plurality of agents that trains models with their own training data and a single server that aggregates the trained models. Federated learning is effectively utilized in environments with high demands for data security and personal information protection. Since data are processed in a distributed manner rather than being centralized, useful information derived from the data can be shared to improve learning models while alleviating concerns regarding data privacy and data security.

However, in conventional federated learning, the degree of classification of the training data owned by each agent varies, and, thus, local model training may proceed in different directions for respective agents during a local training process. This situation causes a discrepancy between the training directions of local and global models, thereby degrading training efficiency and generalization performance.

Accordingly, there is a need for a technology that enables local model representations to learn new knowledge from heterogeneous training data without becoming biased through local training.

### DISCLOSURE OF THE INVENTION

### Problems to be Solved by the Invention

In view of the foregoing, the present disclosure is conceived to provide a learning model building system and method for implementing federated learning by forming a main path for a local model and a hybrid path that combines local and global models, thereby synchronizing representations of the local and global models through knowledge distillation.

The problems to be solved by the present disclosure are not limited to the above-described problems. There may be other problems to be solved by the present disclosure.

### Means for Solving the Problems

As technical means for solving the above-described technical problems, a learning model building system according to an embodiment of the present disclosure includes: a server configured to store and update a global model; and a plurality of agent devices configured to receive the global model from the server, connect the global model between layers of a local model, input a plurality of training data into the local model, and train the local model by calculating a loss between a label value of the training data and an output of the local and global models and updating the local model, and the server receives the trained local model from the plurality of agent devices, and updates the global model using the trained local model.

Further, a learning model building method according to another embodiment of the present disclosure includes: transmitting, by a server, a global model to a plurality of agent devices; connecting, by each of the agent devices, the global model between layers of a local model and inputting a plurality of training data into the local model; calculating, by each of the agent devices, a loss between a label value of the training data and an output of the local and global models and updating the local model; and receiving, by the server, the trained local model from the plurality of agent devices; updating, by the server, the global model using the trained local model.

### Effects of the Invention

According to the present disclosure, federated learning can be performed by applying a knowledge distillation approach via a hybrid path to synchronize representations of local and global models without restricting the representation of the local model.

Further, no additional communication cost is incurred and there is no need to transmit global information such as global gradient information. Consequently, the approach can be efficiently applied to federated learning applications involving agents with limited network bandwidth.

Furthermore, agents are not required to store history information of the local model. Therefore, resource consumption of the agents and system complexity can be reduced, thereby increasing participation rates of the agents.

### BRIEF DESCRIPTION OF THE DRAWINGS

FIG. 1 is a configuration diagram of a learning model building system according to an embodiment of the present disclosure.

FIG. 2 is a diagram illustrating an operation of training a local model by an agent device.

FIG. 3 is a flowchart illustrating a learning model building method according to an embodiment of the present disclosure.

FIG. 4 is a flowchart illustrating a process of inputting a plurality of training data shown in FIG. 3 into the local model.

### MODE FOR CARRYING OUT THE INVENTION

Hereafter, embodiments of the present disclosure will be described in detail with reference to the accompanying drawings. However, it is to be noted that the present disclosure is not limited to the embodiments but can be embodied in various other ways. Also, the accompanying drawings are provided to help easily understand the embodiments of the present disclosure and the technical conception described in the present disclosure is not limited by the accompanying drawings. In the drawings, parts irrelevant to the description are omitted for the simplicity of explanation, and the size, form and shape of each component illustrated in the drawings can be modified in various ways. Like reference numerals denote like parts through the whole document.

Suffixes “module” and “unit” used for components disclosed in the following description are merely intended for easy description of the specification, and the suffixes themselves do not give any special meaning or function. Further, in the following description of the present disclosure, a detailed explanation of known related technologies may be omitted to avoid unnecessarily obscuring the subject matter of the present disclosure.

Throughout the whole document, the term “connected to (contacted with or coupled to)” may be used to designate a connection or coupling of one element to another element and includes both an element being “directly connected to (contacted with or coupled to)” another element and an element being “indirectly connected to (contacted with or coupled to)” another element via another element. Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise.

Further, in describing components of the present disclosure, ordinal numbers such as first, second, etc. can be used only to differentiate the components from each other, but do not limit the sequence or relationship of the components. For example, a first component of the present disclosure may also be referred to as a second component and vice versa.

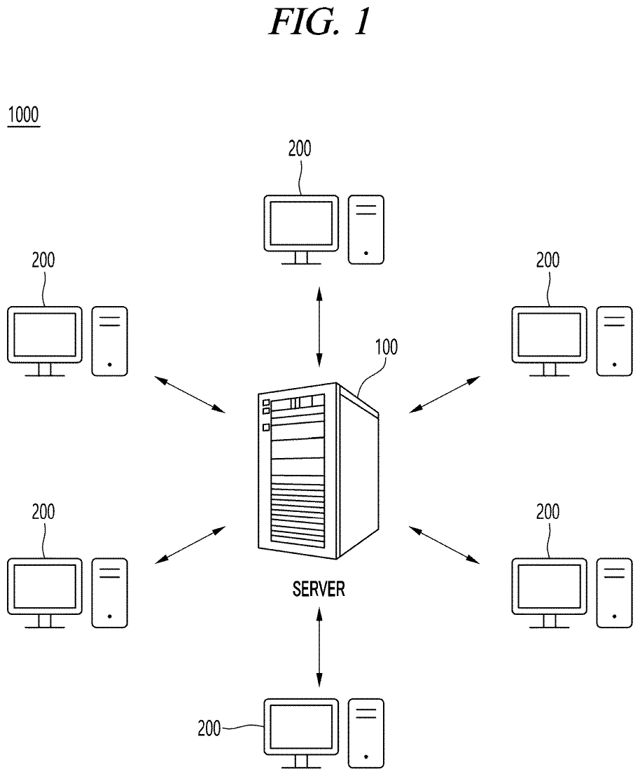

FIG. 1 is a diagram schematically illustrating a learning model building system according to an embodiment of the present disclosure.

A learning model building system 1000 according to an embodiment of the present disclosure will be described with reference to FIG. 1. The learning model building system 1000 includes a server 100 and a plurality of agent devices 200 to build a learning model using federated learning.

The server 100 stores a global model to be build and transmits the global model to the plurality of agent devices 200. Then, the server 100 receives local models trained by each of the plurality of agent devices 200 and updates the global model.

The server 100 initially receives the number of global iterations, the number of local iterations, and a global model, and transmits the global model to some of the plurality of agent devices 200 selected through random sampling. Further, the server 100 transmits information on the set number of local iterations together with the global model to set the number of local model training iterations at the agent devices 200. Furthermore, the server 100 receives trained local models from the plurality of agent devices 200 and updates the global model, and repeats an operation of transmitting the updated global model to some agent devices 200 newly selected through random sampling for the number of global iterations.

To perform the above-described operation, the server 100 may be implemented as a computing device that includes a memory, a processor, and a communication module. The memory stores a global model building program. The memory refers to a non-volatile storage device that continues to maintain stored information even when power is not supplied and a volatile storage device that requires power to maintain the stored information. The memory may perform a function of temporarily or permanently storing data processed by the processor. The memory may include magnetic storage media or flash storage media in addition to the volatile storage device that requires power to maintain the stored information, but the scope of the present disclosure is limited thereto.

The processor executes the global model building program stored in the memory to perform overall operations for training the above-described global model. In the present embodiment, the processor may be implemented as a microprocessor, a central processing unit (CPU), a processor core, a multiprocessor, an application-specific integrated circuit (ASIC), or a field programmable gate array (FPGA), but the scope of the present disclosure is not limited thereto. The processor provides a function of controlling hardware of the server 100 according to the execution of the global model building program. That is, the processor may perform a hardware control function, such as a file system, a memory allocation, a network, a basic library, a timer, a device control (display, media, input device, 3D, or the like), and other utilities, required to execute the program.

Meanwhile, the server 100 may operate in a cloud computing service model, such as software as a service (SaaS), a platform as a service (PaaS), or an infrastructure as a service (IaaS), and may be built in the form of a private cloud, a public cloud, or a hybrid cloud.

The agent device 200 receives a global model and information on the number of local iterations from the server 100, connects the global model between layers of a local model, and trains the local model using a plurality of training data. Specifically, the agent device 200 calculates a loss between a label value of the training data and an output of the local and global models to update the local model, and repeats this process for the number of local iterations to train the local model. Herein, the plurality of training data may be labeled data stored in the agent device 200. Moreover, the agent device 200 may update the local model by calculating an output loss between the local model and the global model.

To perform the above-described operation, the agent device 200 may be implemented as a computing device that includes a memory, a processor, and a communication module. The memory stores a local model building program. The memory refers to a non-volatile storage device that continues to maintain stored information even when power is not supplied and a volatile storage device that requires power to maintain the stored information. The memory may perform a function of temporarily or permanently storing data processed by the processor. The memory may include magnetic storage media or flash storage media in addition to the volatile storage device that requires power to maintain the stored information, but the scope of the present disclosure is limited thereto.

The processor executes the local model building program stored in the memory to perform overall operations for training the above-described local model. In the present embodiment, the processor may be implemented as a microprocessor, a central processing unit (CPU), a processor core, a multiprocessor, an application-specific integrated circuit (ASIC), or a field programmable gate array (FPGA), but the scope of the present disclosure is not limited thereto. The processor provides a function of controlling hardware of the server 100 according to the execution of the global model building program. That is, the processor may perform a hardware control function, such as a file system, a memory allocation, a network, a basic library, a timer, a device control (display, media, input device, 3D, or the like), and other utilities, required to execute the program.

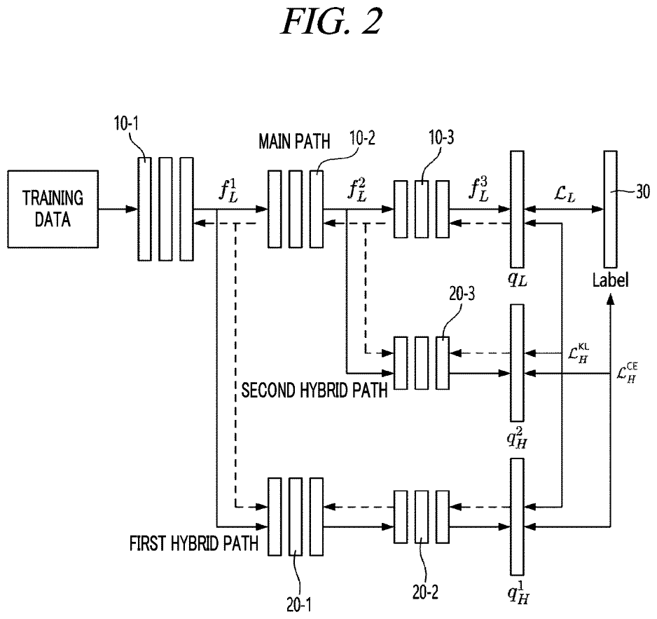

FIG. 2 is a diagram illustrating an operation of training a local model by an agent device. An operation of training the local model by the agent device 200 will be described in detail with reference to FIG. 2.

The agent device 200 divides a local model into a plurality of local blocks 10 and connects the plurality of local blocks 10 to form a main path. In the main path, the plurality of local blocks 10 forms respective layers. Referring to FIG. 2, the agent device 200 divides the local model into a first local block 10-1, a second local block 10-2, and a third local block 10-3, and forms a main path by sequentially connecting the first local block 10-1, the second local block 10-2, and the third local block 10-3.

The agent device 200 configures a plurality of global blocks 20 based on a global model and connects at least one global block 20 to the main path to form a plurality of hybrid paths. In each hybrid path, at least one global block 20 is connected between an nth local block 10 and an (n+1)th local block 10, where n is a natural number, and a first global block 20 forms an (n+1)th layer. Further, the first global block 20 of each hybrid path calculates a feature value based on a feature value of the nth local block 10.

Referring to FIG. 2, the agent device 200 identifies a first global block 20-1, a second global block 20-2, and a third global block 20-3 from the global model. Further, the agent device 200 forms a first hybrid path by connecting the first global block 20-1 and the second global block 20-2 between the first local block 10-1 and the second local block 10-2, and forms a second hybrid path by connecting the third global block 20-3 between the second local block 10-2 and the third local block 10-3.

Herein, in the first hybrid path, the first local block 10-1, the first global block 20-1, and the second global block 20-2 sequentially form layers, and in the second hybrid path, the first local block 10-1, the second local block 10-2, and the third global block 20-3 sequentially form layers. In the first hybrid path, the first global block 20-1 receives a first feature value

$${f}_{L}^{1}$$

of the first local block 10-1 and calculates a feature value, and in the second hybrid path, the third global block 20-3 receives a second feature value

$${f}_{L}^{2}$$

of the second local block 10-2 and calculates a feature value.

The agent device 200 inputs a plurality of training data to the main path formed as described above and trains local blocks through the main path and the plurality of hybrid paths. Since the plurality of hybrid paths is connected to the main path, when the plurality of training data is input into the main path, the plurality of training data may also be input into each of the plurality of hybrid paths.

The agent device 200 updates the local model by calculating a label value of the training data, an output loss between the main path and the plurality of hybrid paths, and an output loss between the main path and the plurality of hybrid paths.

Referring to FIG. 2, the agent device 200 calculates a first loss value L_{L} between a first output value q_{L} of the main path and a label value 30 of the training data, a second loss value

$${L}_{H}^{C E}$$

between a plurality of second output values

$${q}_{H}^{1} , {q}_{H}^{2}$$

of each hybrid path and the label value 30 of the training data, and a third loss value

$${L}_{H}^{K H}$$

between the first output value q_{L} and the plurality of second output values

$${q}_{H}^{1} , {q}_{H}^{2} ,$$

and updates the local model based on the first loss value L_{L}, the second loss value

$${L}_{H}^{C E} ,$$

and the third loss value

$${L}_{H}^{KH} .$$

Herein, the first loss value L_{L} and the second loss value

$${L}_{H}^{C E}$$

are calculated using cross-entropy. The first loss value L_{L} is calculated by Equation 1, and the second loss value

$${L}_{H}^{C E}$$

is calculated by Equation 2.

$${L}_{L} = CrossEntropy ( {q}_{L} , y ) \qquad [ Equation 1 ]$$

$${L}_{H}^{CE} = \frac{1}{M - 1} {\sum }_{m = 1}^{M - 1} CrossEntropy ( {q}_{H}^{m} , y ) \qquad [ Equation 2 ]$$

In Equation 1 and Equation 2, y denotes the label value of training data.

Further, the third loss value

$${L}_{H}^{K H}$$

is calculated using Kullback-Leibler divergence and is calculated by Equation 3.

$${L}_{H}^{KL} = \frac{1}{M - 1} {\sum }_{m = 1}^{M - 1} KL ( {q}_{H}^{m} , {q}_{L} ) \qquad [ Equation 3 ]$$

The agent device 200 calculates a parameter gradient based on the first loss value L_{L}, the second loss value

$${L}_{H}^{C E}$$

and the third loss value

$${L}_{H}^{KH}$$

calculated as described above, and updates the plurality of local blocks 10-1, 10-2 and 10-3 included in the main path based on the parameter gradient. The agent device 200 applies a final loss function defined by Equation 4 to the main path, the first hybrid path, and the second hybrid path using a gradient descent algorithm to calculate parameter gradients with respect to the final loss function, and updates only parameters included in the main path based on the calculated parameter gradients.

Herein, the agent device 200 maintains parameters of the global block 20 without updating the parameters while repeating an operation of updating the local model for the number of local iterations. In this process, a knowledge distillation approach is applied, and training may be performed to update the local blocks in a learning direction of the global model based on output values of the plurality of hybrid paths.

$$L = {L}_{L} + {λ}_{1} {L}_{H}^{CE} + {λ}_{2} {L}_{H}^{KL} \qquad [ Equation 4 ]$$

In Equation 4, λ₁ and λ₂ are hyperparameters that determine weights of respective terms.

Then, when training of the local model is completed, the agent device 200 transmits the trained local model to the server 100, and the server 100 updates the global model by calculating an average of parameters of the trained local models received from the agent devices 200. The server 100 updates the global model using the trained local models received from the plurality of agent devices 200, and trains the global model by repeating an operation of transmitting the updated global model to some agent devices 200 newly selected through random sampling for the number of global iterations.

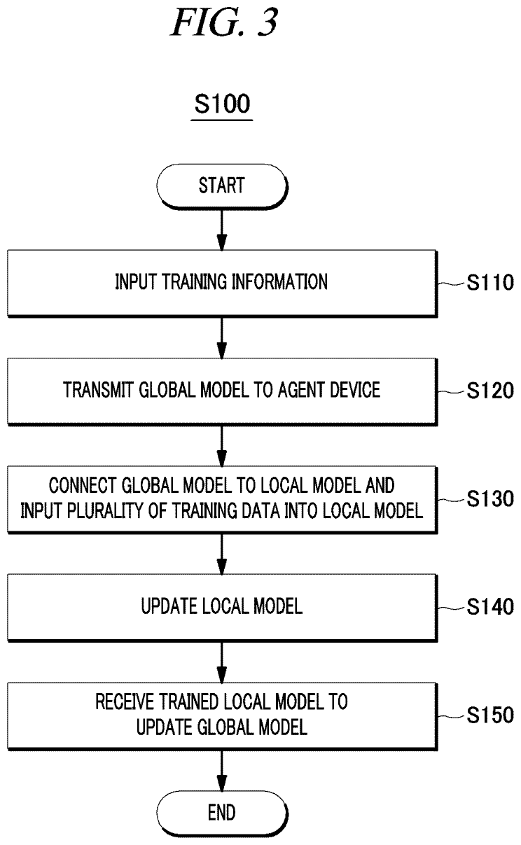

FIG. 3 is a flowchart illustrating a learning model building method according to an embodiment of the present disclosure.

Referring to FIG. 1 to FIG. 3, a learning model building method (S100) using the learning model building system 1000 according to an embodiment of the present disclosure will be described. The server 100 initially receives training information including a global model, the number of global iterations, and the number of local iterations (process S110), and transmits the global model to the plurality of agent devices 200 (process S120). Each agent device 200 that has received the global model connects the global model between layers of a local model and then inputs a plurality of training data into the local model (process S130). Thereafter, the agent device 200 calculates a loss between a label value of the training data and an output of the local and global models to update the local model (process S140). When training of the local model is completed at the agent device 200, the server 100 receives the trained local models from the plurality of agent devices 200 and updates the global model (process S150).

Hereinafter, each process of the learning model building method (S100) will be described in detail.

In the process S120 of transmitting the global model to the plurality of agent devices 200 by the server 100, the server 100 transmits the global model to some agent devices 200 selected from among the plurality of agent devices 200 through random sampling. Herein, the server 100 transmits information on the set number of local iterations together with the global model to set the number of local model training iterations at the agent devices 200.

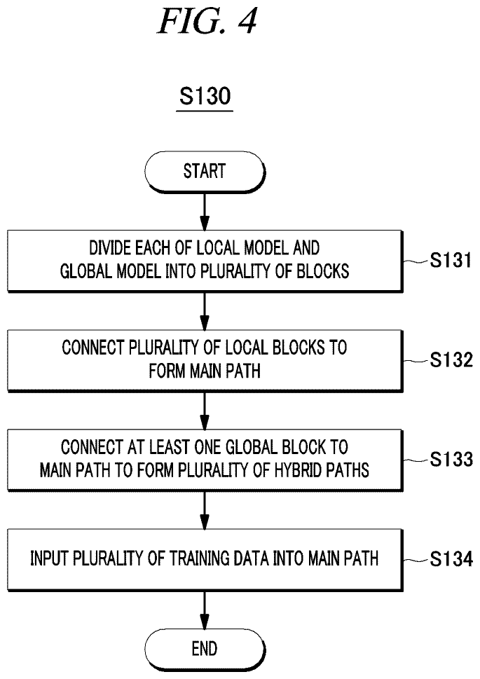

FIG. 4 is a flowchart illustrating a process of training the local and global models shown in FIG. 3.

Hereinafter, the process S130 of inputting the plurality of training data into the local model at the agent device 200 will be described with reference to FIG. 2 and FIG. 4.

The agent device 200 divides the local model into a plurality of local blocks 10 and divides the global model into a plurality of global blocks 20 (process S131), and connects the plurality of local blocks 10 to form a main path (process S132). In the main path, the plurality of local blocks 10 forms respective layers. Referring to FIG. 2, the agent device 200 divides the local model into the first local block 10-1, the second local block 10-2, and the third local block 10-3, and forms a main path by sequentially connecting the first local block 10-1, the second local block 10-2, and the third local block 10-3.

Then, the agent device 200 connects at least one global block 20 to the main path to form a plurality of hybrid paths (process S133). In each hybrid path, at least one global block 20 is connected between an nth local block 10 and an (n+1)th local block 10, where n is a natural number, and the first global block 20 forms an (n+1)th layer. Further, the first global block 20 of each hybrid path calculates a feature value based on a feature value of the nth local block 10.

Referring to FIG. 2, the agent device 200 divides the global model into the first global block 20-1, the second global block 20-2, and the third global block 20-3. Further, the agent device 200 forms a first hybrid path by connecting the first global block 20-1 and the second global block 20-2 between the first local block 10-1 and the second local block 10-2, and forms a second hybrid path by connecting the third global block 20-3 between the second local block 10-2 and the third local block 10-3.

Herein, in the first hybrid path, the first local block 10-1, the first global block 20-1, and the second global block 20-2 sequentially form layers, and in the second hybrid path, the first local block 10-1, the second local block 10-2, and the third global block 20-3 sequentially form layers. In the first hybrid path, the first global block 20-1 receives the first feature value

$${f}_{L}^{1}$$

of the first local block 10-1 and calculates a feature value, and in the second hybrid path, the third global block 20-3 receives the second feature value

$${f}_{L}^{2}$$

of the second local block 10-2 and calculates a feature value.

Then, the agent device 200 inputs a plurality of training data into the main path to which the plurality of hybrid paths is connected (process S134), thereby starting training of the local model. Since the plurality of hybrid paths is connected to the main path, when the plurality of training data is input into the main path, the plurality of training data may also be input into each of the plurality of hybrid paths.

Hereinafter, the process S140 of updating the local model by the agent device 200 will be described with reference to FIG. 2. The agent device 200 trains local blocks through the main path and the plurality of hybrid paths formed as described above, and updates the local model by calculating a label value of the training data, an output loss between the main path and the plurality of hybrid paths, and an output loss between the main path and the plurality of hybrid paths.

Referring to FIG. 2, the agent device 200 calculates the first loss value L_{L} between the first output value q_{L} of the main path and the label value 30 of the training data, the second loss value

$${L}_{H}^{C E}$$

between the plurality of second output values

$${q}_{H}^{1} , {q}_{H}^{2}$$

of each hybrid path and the label value 30 of the training data, and the third loss value

$${L}_{H}^{K H}$$

between the first output value q_{L} and the plurality of second output values

$${q}_{H}^{1} , {q}_{H}^{2} ,$$

and updates the local model based on the first loss value L_{L}, the second loss value

$${L}_{H}^{C E} ,$$

and the third loss value

$${L}_{H}^{K H} .$$

Herein, the first loss value L_{L} and the second loss value

$${L}_{H}^{C E}$$

are calculated using cross-entropy. The first loss value L_{L} is calculated by Equation 1, and the second loss value

$${L}_{H}^{C E}$$

is calculated by Equation 2.

$${L}_{L} = CrossEntropy ( {q}_{L} , y ) \qquad [ Equation 1 ]$$

$${L}_{H}^{CE} = \frac{1}{M - 1} {\sum }_{m = 1}^{M - 1} CrossEntropy ( {q}_{H}^{m} , y ) \qquad [ Equation 2 ]$$

In Equation 1 and Equation 2, y denotes the label value of training data.

Further, the third loss value

$${L}_{H}^{K H}$$

is calculated using Kullback-Leibler divergence and is calculated by Equation 3.

$${L}_{H}^{KL} = \frac{1}{M - 1} {\sum }_{m = 1}^{M - 1} KL ( {q}_{H}^{m} , {q}_{L} ) \qquad [ Equation 3 ]$$

The agent device 200 calculates a parameter gradient based on the first loss value L_{L}, the second loss value

$${L}_{H}^{C E} ,$$

and the third loss value

$${L}_{H}^{KH}$$

calculated as described above, and updates the plurality of local blocks 10-1, 10-2 and 10-3 included in the main path based on the parameter gradient. The agent device 200 applies a final loss function defined by Equation 4 to the main path, the first hybrid path, and the second hybrid path using a gradient descent algorithm to calculate parameter gradients with respect to the final loss function, and updates only parameters included in the main path based on the calculated parameter gradients.

Herein, the agent device 200 maintains parameters of the global block 20 without updating the parameters while repeating an operation of updating the local model for the number of local iterations. In this process, a knowledge distillation approach is applied, and training may be performed to update the local blocks in a learning direction of the global model based on output values of the plurality of hybrid paths.

$$L = {L}_{L} + {λ}_{1} {L}_{H}^{CE} + {λ}_{2} {L}_{H}^{KL} \qquad [ Equation 4 ]$$

In Equation 4, λ₁ and λ₂ are hyperparameters that determine weights of respective terms.

Hereinafter, the process S150 of updating the global model will be described. When training of the local model is completed, the agent device 200 transmits the trained local model to the server 100, and the server 100 updates the global model by calculating an average of parameters of the trained local models received from the agent devices 200. Then, if the number of updates of the global model does not satisfy the number of global iterations, the server 100 performs the process S120 again. The server 100 transmits the global model that has been updated in a previous round to some agent devices 200 newly selected through random sampling. When the number of updates of the global model satisfies the number of global iterations, the server 100 returns the global model.

The present disclosure can be embodied in a storage medium including instruction codes executable by a computer such as a program module executed by the computer. A computer-readable medium can be any usable medium which can be accessed by the computer and includes all volatile/non-volatile and removable/non-removable media. Further, the computer-readable medium may include all computer storage media. The computer storage media include all volatile/non-volatile and removable/non-removable media embodied by a certain method or technology for storing information such as computer-readable instruction code, a data structure, a program module or other data.

The method and system of the present disclosure have been explained in relation to a specific embodiment, but their components or a part or all of their operations can be embodied by using a computer system having general-purpose hardware architecture.

It would be understood by a person with ordinary skill in the art that various changes and modifications may be made based on the above description without changing technical conception and essential features of the present disclosure. Thus, it is clear that the above-described embodiments are illustrative in all aspects and do not limit the present disclosure. The scope of the present disclosure is defined by the following claims. It shall be understood that all modifications and embodiments conceived from the meaning and scope of the claims and their equivalents are included in the scope of the present disclosure.

The scope of the present disclosure is defined by the following claims rather than by the detailed description of the embodiment. It shall be understood that all modifications and embodiments conceived from the meaning and scope of the claims and their equivalents are included in the scope of the present disclosure.

What is claimed is:

1. A learning model building system that builds a learning model using federated learning, comprising:
a server configured to store and update a global model; and
a plurality of agent devices configured to receive the global model from the server, connect the global model between layers of a local model, input a plurality of training data into the local model, and train the local model by calculating a loss between a label value of the training data and an output of the local and global models and updating the local model,
wherein the server receives the trained local model from the plurality of agent devices, and updates the global model using the trained local model.

2. The learning model building system of claim 1,
wherein the agent device updates the local model by calculating an output loss between the local model and the global model.

3. The learning model building system of claim 1,
wherein the agent device divides each of the local and global models into a plurality of blocks, connects a plurality of local blocks of the local model to form a main path, connects at least one global block of the global model to the main path to form a plurality of hybrid paths, and inputs the plurality of training data into the main path, and
in the main path, the plurality of local blocks forms respective layers, and
in the hybrid path, the at least one global block is connected between an nth local block and an (n+1)th local block, where n is a natural number, and a first global block forms an (n+1)th layer.

4. The learning model building system of claim 3,
wherein the first global block of each hybrid path calculates a feature value based on a feature value of the nth local block.

5. The learning model building system of claim 4,
wherein the agent device calculates a first loss value between a first output value of the main path and a label value of the training data, a second loss value between a plurality of second output values of each hybrid path and the label value of the training data, and a third loss value between the first output value and the plurality of second output values, and updates the local model based on the first loss value, the second loss value, and the third loss value.

6. The learning model building system of claim 5,
wherein the agent device calculates a parameter gradient based on the first loss value, the second loss value, and the third loss value, and updates the plurality of local blocks included in the main path based on the parameter gradient.

7. The learning model building system of claim 5,
wherein the agent device calculates the first loss value and the second loss value using cross-entropy, and
the agent device calculates the third loss value using Kullback-Leibler divergence.

8. A learning model building method that builds a learning model using federated learning, comprising:
transmitting, by a server, a global model to a plurality of agent devices;
connecting, by each of the agent devices, the global model between layers of a local model and inputting a plurality of training data into the local model;
calculating, by each of the agent devices, a loss between a label value of the training data and an output of the local and global models and updating the local model;
receiving, by the server, the trained local model from the plurality of agent devices;
updating, by the server, the global model using the trained local model.

9. The learning model building method of claim 8,
wherein updating the local model,
the local model is updated by calculating an output loss between the local model and the global model.

10. The learning model building method of claim 8,
wherein inputting the plurality of training data into the local model includes:
dividing each of the local and global models into a plurality of blocks;
connecting a plurality of local blocks of the local model to form a main path;
connecting at least one global block of the global model to the main path to form a plurality of hybrid paths; and
inputting the plurality of training data into the main path, and
in the main path, the plurality of local blocks forms respective layers, and
in the hybrid path, the at least one global block is connected between an nth local block and an (n+1)th local block, where n is a natural number, and a first global block forms an (n+1)th layer.

11. The learning model building method of claim 10,
wherein inputting the plurality of training data into the main path,
the first global block of the hybrid path calculates a feature value based on a feature value of the nth local block.

12. The learning model building method of claim 11,
wherein updating the local model,
a first loss value between a first output value of the main path and a label value of the training data, a second loss value between a plurality of second output values of each hybrid path and the label value of the training data, and a third loss value between the first output value and the plurality of second output values are calculated, and the local model is updated based on the first loss value, the second loss value, and the third loss value.

13. The learning model building method of claim 12,
wherein updating the local model,
a parameter gradient is calculated based on the first loss value, the second loss value, and the third loss value, and the plurality of local blocks included in the main path is updated based on the parameter gradient.

14. The learning model building method of claim 12,
wherein updating the local model,
the first loss value and the second loss value are calculated using cross-entropy, and
the third loss value is calculated using Kullback-Leibler divergence.
